(19) United States
(12) Patent Application Publication
(10) Pub. No.: US 2026/0147609 A1
(43) Pub. Date: May 28, 2026

(54) SYSTEM AND METHOD FOR MONITORING UNMANNED VEHICLE

(71) Applicant: WISTRON CORPORATION, New Taipei City (TW)

(72) Inventors: Yu Hung HSU, New Taipei City (TW); Hung Chou CHEN, New Taipei City (TW)

(73) Assignee: WISTRON CORPORATION, New Taipei City (TW)

(21) Appl. No.: 19/066,367

(22) Filed: Feb. 28, 2025

(30) Foreign Application Priority Data
Nov. 25, 2024 (TW) 113145394

(51) Int. Cl. G06F 9/48; G06F 9/445; G07C 5/06

(52) U.S. Cl. CPC G06F 9/4881; G06F 9/44505; G07C 5/06

(57) ABSTRACT

The present disclosure provides a system and method for monitoring an unmanned vehicle. The method for monitoring an unmanned vehicle is applied to a data processing apparatus, and includes: executing an initialization procedure, by using the data processing apparatus, to receive operation data; processing the operation data to retain key portion data; processing the key portion data to generate a plurality of pictures; and merging the plurality of pictures to generate a video. The operation data is data generated by an unmanned vehicle during operation.

### CROSS-REFERENCE TO RELATED APPLICATIONS

This non-provisional application claims priority under 35 U.S.C. § 119(a) to Patent Application No. 113145394 filed in Taiwan, R.O.C. on Nov. 25, 2024, the entire contents of which are hereby incorporated by reference.

### BACKGROUND

### Technical Field

The present disclosure relates to a system and method for monitoring an unmanned vehicle, and in particular, to a system and method that are for monitoring an unmanned vehicle and that provide a cross-platform analysis capability.

### Related Art

A system and method for monitoring an unmanned vehicle may be widely applied to fields such as self-driving vehicles, unmanned aerial vehicles, and industrial automation devices, and have a wide market demand. When operation data of an unmanned vehicle is analyzed, a commonly used method is to use a robot operating system (Robot Operating System, ROS) bag (ROSBAG) tool of a robot operating system to record and store the operation data of the unmanned vehicle. The ROSBAG tool can record data of a topic (Topic) of the robot operating system into a file for subsequent analysis.

### SUMMARY

An embodiment of the present disclosure provides a system for monitoring an unmanned vehicle. The system includes an unmanned vehicle and a data processing apparatus. The unmanned vehicle generates operation data during operation. The data processing apparatus includes an initialization module, a data processing module, and a picture generation module. The initialization module is configured to execute an initialization procedure to receive the operation data. The data processing module is configured to process the operation data to retain key portion data. The picture generation module is configured to process the key portion data to generate a plurality of pictures.

An embodiment of the present disclosure provides a method for monitoring an unmanned vehicle. The method is applied to a data processing apparatus, and includes: executing an initialization procedure, by using the data processing apparatus, to receive operation data; processing the operation data to retain key portion data; and processing the key portion data to generate a plurality of pictures. The operation data is data generated by an unmanned vehicle during operation.

### BRIEF DESCRIPTION OF THE DRAWINGS

FIG. 1 is a block diagram of a system for monitoring an unmanned vehicle according to an embodiment of the present disclosure;

FIG. 2 is a flowchart of a method for monitoring an unmanned vehicle according to an embodiment of the present disclosure;

FIG. 3 is a flowchart of an initialization procedure of a robot operating system in a method for monitoring an unmanned vehicle according to an embodiment of the present disclosure;

FIG. 4 is a flowchart of a data recording procedure in a method for monitoring an unmanned vehicle according to an embodiment of the present disclosure;

FIG. 5 is a flowchart of processing operation data to retain key portion data in a method for monitoring an unmanned vehicle according to an embodiment of the present disclosure;

FIG. 6 is a schematic diagram of displaying a global costmap in a method for monitoring an unmanned vehicle according to an embodiment of the present disclosure; and

FIG. 7 is a schematic diagram of displaying a local costmap in a method for monitoring an unmanned vehicle according to an embodiment of the present disclosure.

### DETAILED DESCRIPTION

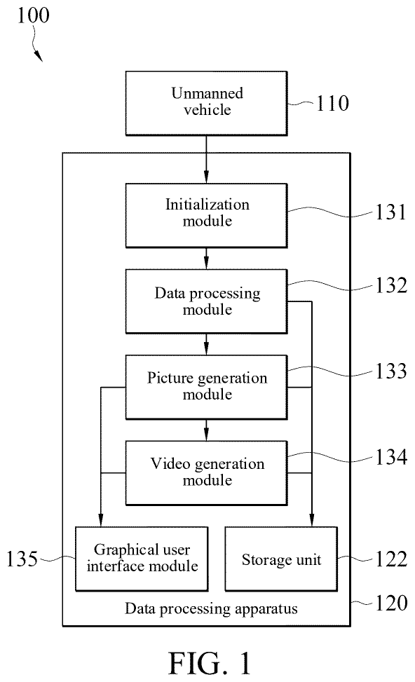

FIG. 1 is a block diagram of a system 100 for monitoring an unmanned vehicle according to an embodiment of the present disclosure. Refer to FIG. 1. In the embodiment of FIG. 1, the system 100 for monitoring an unmanned vehicle includes an unmanned vehicle 110 and a data processing apparatus 120. The unmanned vehicle 110 is configured to provide operation data for the data processing apparatus 120. The unmanned vehicle 110 refers to an automated vehicle that does not require human driving, and includes a camera drone for aerial photography and a transport vehicle for warehousing and factory automation, for example, an automated guided vehicle (Automated Guided Vehicle, AGV) and an autonomous mobile robot (Autonomous Mobile Robot, AMR). The unmanned vehicle 110 is usually provided with one or more kinds of sensors based on an application field or a purpose of the unmanned vehicle 110, including a lidar (LiDAR), a photographic lens, an ultrasonic sensor, an infrared sensor, an accelerometer, a gyroscope, a global positioning system, an environmental sensor, or the like. The sensor of the unmanned vehicle 110 may generate the operation data during operation of the unmanned vehicle 110. The data processing apparatus 120 of the system 100 for monitoring an unmanned vehicle may be a server, a personal computer, or just a smart mobile device. The data processing apparatus 120 may further include a central processing unit (central processing unit, CPU), a micro control unit (micro control unit, MCU), a microprocessor (microprocessor), a digital signal processor (digital signal processor, DSP), a programmable controller, an application specific integrated circuit (application specific integrated circuit, ASIC), a graphics processing unit (graphics processing unit, GPU), an image signal processor (image signal processor, ISP), an image processing unit (image processing unit, IPU), an arithmetic logic unit (arithmetic logic unit, ALU), a complex programmable logic device (complex programmable logic device, CPLD), a field programmable gate array (field programmable gate array, FPGA), another similar element, or a combination of the foregoing elements. The data processing apparatus 120 is configured to receive the operation data of the unmanned vehicle 110 in real time and execute an initialization module 131, a data processing module 132, and a graphical user interface module 135 to process the operation data in real time, so as to convert processed operation data into a picture or a video, and display the picture or the video on a playback window of a graphical user interface. In addition, the data processing apparatus 120 may alternatively store the operation data, the picture, and the video into a storage unit 122 for subsequent analysis.

Refer to FIG. 1. In the embodiment of FIG. 1, the system 100 for monitoring an unmanned vehicle includes: the initialization module 131, a data processing module 132, a picture generation module 133, a video generation module 134, and a data recording procedure. The initialization module 131 is configured to execute an initialization procedure to receive the operation data, and configured to execute a software library loading procedure. The initialization module 131 may execute the initialization procedure to initialize a node (Node) of a robot operating system. The node refers to an independent executable unit, and is usually configured to perform a specific task or function, for example, sensing, controlling, navigating, or data processing. In an embodiment, the initialization module 131 may execute the initialization procedure to start the node of the robot operating system and subscribe to a topic (Topic) of the robot operating system, thereby receiving the operation data of the unmanned vehicle 110 in real time. In addition, the initialization module 131 may also execute the software library loading procedure to load a tool and software library required for processing the operation data, for example, a compression library, a plotting library, and a computer vision library. The data processing module 132 is configured to process the operation data to retain key portion data. In other words, the data processing module 132 may screen and process the operation data to retain the key portion data in the operation data.

In addition, the data processing module 132 may process the operation data by using a loaded software library, for example, the compression library. The key portion data retained by the data processing module 132 may be compressed by using the compression library to reduce an amount of data.

In addition, the data processing module 132 includes the picture generation module 133, and the picture generation module 133 is configured to process the key portion data to generate a plurality of pictures. In an embodiment, the picture generation module 133 may include the plotting library, and a plotting function in the plotting library may process the key portion data to generate a visual image, for example, a costmap. In addition, the picture generation module 133 may generate a file name for the visual image according to a predetermined naming rule, and store, in a picture encoding format, the visual image generated by the picture generation module 133 into a designated directory of the storage unit 122 of the data processing apparatus 120. In an embodiment, the plotting library included in the picture generation module 133 may be a Matplotlib plotting library.

In addition, the data processing module 132 includes the video generation module 134, and the video generation module 134 is configured to merge the plurality of pictures to generate a video with a coherent animation effect. In an embodiment, the video generation module 134 may include the computer vision library, and may sort the plurality of pictures in the designated directory according to file names and merge the plurality of pictures into the video. The video generated by the video generation module 134 is then stored, in a video encoding format (for example, a format such as AVI or MP4), into the storage unit 122 of the data processing apparatus 120 for subsequent playback and analysis. In an embodiment, the computer vision library included in the video generation module 134 may be an OpenCV computer vision library.

In an embodiment, the data processing module 132 may execute a data processing procedure. The data processing procedure includes one or more of the following steps: a noise processing step, a redundant data removal step, an obstacle priority evaluation step, and a key event extraction step. The noise processing step is for filtering and smoothing noise in the operation data, where the noise includes false detection and positioning drift of a LiDAR. The redundant data removal step is for removing, from the operation data, redundant data that is not related to navigation decision-making, where the redundant data includes static obstacle data or cluttered object data. The obstacle priority evaluation step is for evaluating a threat level of an obstacle in the operation data, and assigning a priority to the obstacle, where the threat level is evaluated based on a proximity distance, a size, and a moving speed of the obstacle. The key event extraction step is for extracting key event data from the operation data, where the key event data is data related to a key event, and the key event includes a sudden appearance of the obstacle, a sudden change of path planning, and an abnormal change in speed.

In an embodiment, the system 100 for monitoring an unmanned vehicle further includes the graphical user interface module 135. The graphical user interface module 135 is configured to display the picture generated by the picture generation module 133 or the video generated by the video generation module 134. The graphical user interface module 135 may run the graphical user interface to generate one or more playback windows. In an embodiment, the picture or the video may be simultaneously displayed (or played) in a plurality of playback windows of the graphical user interface. For example, the picture or the video presented in a form of a global costmap (Global Costmap) is displayed (or played) through a first playback window, to provide information about an overall environment; and the picture or the video presented in a form of a local costmap (Local Costmap) is displayed (or played) through a second playback window, to highlight information about a specific area or position.

In addition, the data processing module 132 further includes the data recording procedure, a visualization enhancement procedure, and an automated report generation procedure. The data processing module 132 may execute the data recording procedure to process the operation data and screen the key portion data out of the operation data. In an embodiment, the data recording procedure includes the noise processing step, the redundant data removal step, the obstacle priority evaluation step, and the key event extraction step. The data processing module 132 may execute the visualization enhancement procedure to further improve a visualization effect of the key portion data in the operation data. In an embodiment, the visualization enhancement procedure includes: adding a level mark of different colors or sizes to the picture to identify the priority of the obstacle in the operation data; or adding a positioning mark or a highlight mark to a timeline of the video to highlight the key event of the operation data. The data processing module 132 may execute the automated report generation procedure to generate an analysis report about the operation data. In an embodiment, the automated report generation procedure includes: automatically generating a key event report based on the key event data extracted from the operation data, where the key event report includes a key event time point, an unmanned vehicle status, and a sensor reading; or automatically generating a trend analysis report based on the operation data obtained in long duration, where the trend analysis report includes a speed change trend, obstacle distribution statistics, and path planning efficiency.

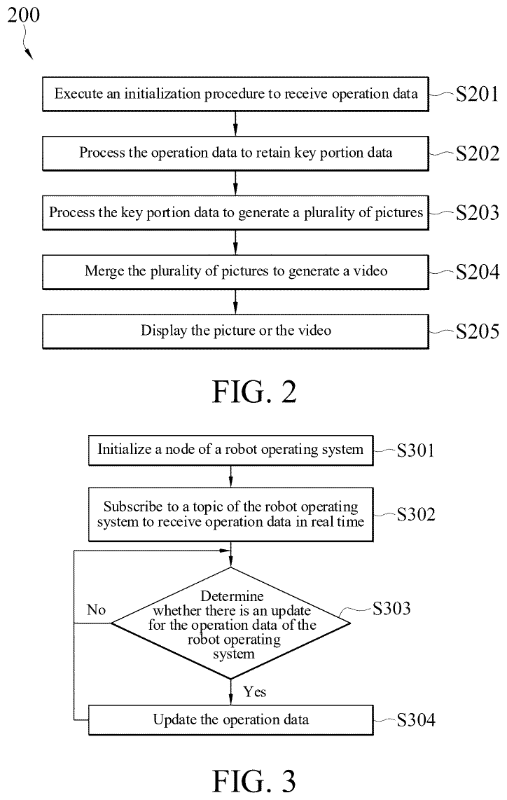

FIG. 2 is a flowchart of a method 200 for monitoring an unmanned vehicle according to an embodiment of the present disclosure. Refer to FIG. 2. In the embodiment of FIG. 2, the method 200 for monitoring an unmanned vehicle includes the following steps: executing an initialization procedure to receive operation data (S201); processing the operation data to retain key portion data (S202); processing the key portion data to generate a plurality of pictures (S203); merging the plurality of pictures to generate a video (S204); and displaying a picture or a video (S205). The operation data is data generated by an unmanned vehicle 110 during operation.

In an embodiment, step S201 may include executing an initialization procedure of a robot operating system, where the initialization procedure includes initializing a node of the robot operating system, and subscribing to a topic of the robot operating system to receive the operation data of the unmanned vehicle 110 in real time.

In an embodiment, step S201 may include executing a software library loading procedure, including loading one or more of the following software libraries: a compression library, a plotting library, and a computer vision library.

In an embodiment, step S202 may include performing one or more of the following steps: a noise processing step, a redundant data removal step, an obstacle priority evaluation step, and a key event extraction step. In addition, the operation data that can be processed in step S202 includes: costmap data, data of a position and a posture of the unmanned vehicle 110, data of path planning and a route of the unmanned vehicle 110, LiDAR scanning data, log data of the ROS, and the like. The costmap data usually includes data of a static obstacle and an object in an environment. The costmap data may be classified into global costmap data and local costmap data. In addition, processed key portion data may be compressed by using the compression library to reduce a storage demand. This has a significant advantage in data management of the method 200 for monitoring an unmanned vehicle.

In an embodiment, in step S203, the plotting library may be used to process the key portion data of the operation data to create a visual image, and the visual image is stored into a storage unit 122 of a data processing apparatus 120 in a picture encoding format. For example, the plotting library may be a Matplotlib plotting library. The Matplotlib plotting library is a data visualization library, and may process the key portion data to create the visual image, for example, a costmap. The visual costmap may include only filtered high-priority data. Noise is reduced and the key portion data is highlighted. For example, in the costmap, different colors, different color depths, or marks with different sizes may be used to distinguish obstacles with different priorities, to highlight a position or an area of the key portion data. For example, the Matplotlib plotting library includes an image displaying function: ax.imshow(data, extent=(x_min, x_max, y_min, y_max), cmap=color_map, origin=‘lower’). A main function of the image displaying function is to create the visual image from a two-dimensional array of the operation data. “data” represents a data matrix of the costmap data in the operation data; “extend” represents setting an image displaying range; “cmap” represents specified color mapping; and “origin” represents setting an origin position of an image. In addition, the Matplotlib plotting library includes a plotting style function: ax.plot (x, y, ‘ro’). A main function of the plotting style function is to draw a path or a position point on a map. “x”, “y” represents coordinate data of a path or a position; and “‘ro’” represents drawing with a red dot.

In an embodiment, in step S204, the computer vision library may be used to merge the plurality of pictures into a video with a coherent animation effect, and the video is stored into the storage unit 122 of the data processing apparatus 120 in a video encoding format. The computer vision library may be an OpenCV computer vision library. The OpenCV computer vision library is a widely used computer vision library, and is mainly used for processing and generating a video. The OpenCV computer vision library may merge the pictures that are generated by the Matplotlib plotting library into the video according to a sequence (for example, a sequence of file names or file times), so that an important event and a data change can be highlighted during a playback of the video. For example, the OpenCV computer vision library includes a video creation function: cv2.VideoWriter(video_path, cv2.VideoWriter_fourcc(*‘XVID’), frame_rate, (width, height)). A main function of the video creation function is to merge the pictures into the video. “video_path” represents a film saving path; “cv2.VideoWriter_fourcc(*‘XVID’)” represents setting the video encoding format; “frame_rate” represents a quantity of frames displayed per second; and “(width, height)” represents a width and a height of the video.

In an embodiment, the method 200 for monitoring an unmanned vehicle further includes a step of displaying the picture or the video (S205). In step S205, the picture or the video may be displayed in one or more playback windows of a graphical user interface. For example, the picture or the video presented in a form of a global costmap may be displayed in a first playback window, to provide information about an overall environment; and the picture or the video presented in a form of a local costmap may be displayed in a second playback window, to display detailed information about an environment of an adjacent area of the unmanned vehicle 110. In an embodiment, a displaying size of the global costmap is greater than a displaying size of the local costmap, or a size of the first playback window is greater than a size of the second playback window, but this is not limited thereto.

FIG. 3 is a flowchart of the initialization procedure of the robot operating system in the method 200 for monitoring an unmanned vehicle according to an embodiment of the present disclosure. Refer to FIG. 3. In the embodiment of FIG. 3, the initialization procedure of the robot operating system can enable the data processing apparatus 120 to receive the operation data of the unmanned vehicle 110 in real time. The initialization procedure of the robot operating system includes the following steps: initializing a node of the robot operating system (S301); subscribing to a topic of the robot operating system to receive the operation data in real time (S302); determining whether there is an update for the operation data in the robot operating system (S303); and updating the operation data in response to that there is an update for the operation data (S304). In addition, in response to that there is no update for the operation data or after step S304 is performed, the initialization procedure returns to step S303, to continue to perform step S303.

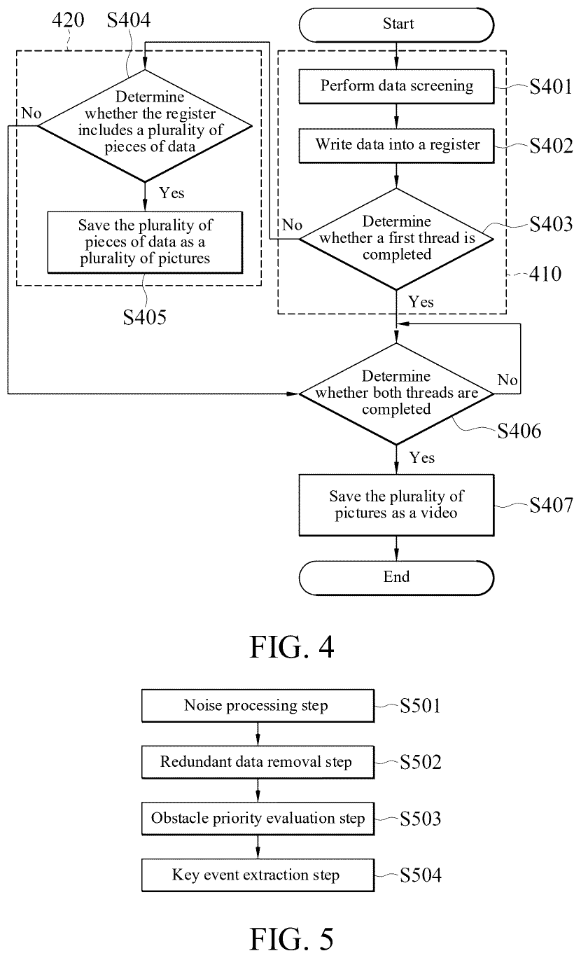

FIG. 4 is a flowchart of a data recording procedure of the method 200 for monitoring an unmanned vehicle according to an embodiment of the present disclosure. Refer to FIG. 4. In the embodiment of FIG. 4, the data recording procedure includes a first thread 410 and a second thread 420. The first thread 410 and the second thread 420 may be executed in parallel, where the first thread 410 is for processing the operation data, and the second thread 420 is for generating a plurality of pictures.

Refer to FIG. 4. In the data recording procedure, the following steps are performed through the first thread 410: performing data screening (S401), writing data into a register (S402), and determining whether the first thread 410 is completed (S403). In the step of performing data screening (S401), the operation data may be processed and the key portion data is screened out of the operation data. Step S401 may include one or more of the following steps: the noise processing step, the redundant data removal step, the obstacle priority evaluation step, and the key event extraction step. In the step of writing data into a register (S402), the key portion data may be written into the register of the data processing apparatus 120. In the step of determining whether the first thread 410 is completed (S403), whether the first thread 410 is completed may be determined. If the first thread 410 is not completed, the second thread 420 is notified, and step S404 is performed. If the first thread 410 is completed, a notification signal indicating that the first thread 410 is completed is sent.

Refer to FIG. 4. In the data recording procedure, the following steps are performed through the second thread 420: determining whether the register includes a plurality of pieces of data (S404); and saving the plurality of pieces of data as the plurality of pictures (S405). In the step of determining whether the register includes a plurality of pieces of data (S404), whether there is the key portion data in the register of the data processing apparatus 120 may be determined. If there is the key portion data in the register, the step of saving the plurality of pieces of key portion data as the plurality of pictures (S405) is performed. If there is no key portion data in the register, a notification signal indicating that the second thread 420 is completed is sent. In the step of saving the data as the pictures (S405), the key portion data that is in the register is processed to create a visual image, and the generated visual image is stored into the storage unit 122 of the data processing apparatus 120 in a picture encoding format.

Refer to FIG. 4. The data recording procedure includes a step of determining whether both threads are completed (S406) and a step of saving the plurality of pictures as a video (S407). In the step of determining whether both threads are completed (S406), whether the first thread 410 and the second thread 420 are completed may be determined. When the notification signal indicating that the first thread 410 is completed in step S403 and the notification signal indicating that the second thread 420 is completed in step S404 are received, it indicates that both the first thread 410 and the second thread 420 are completed. In this case, the step of saving the plurality of pictures as a video (S407) may be performed, otherwise, the data recording procedure returns to step S406. In the step of saving the plurality of pictures as a video (S407), the plurality of pictures may be merged to generate the video with a coherent animation effect, and the video is stored into the storage unit 122 of the data processing apparatus 120 in a video encoding format.

FIG. 5 is a flowchart of processing the operation data to retain the key portion data (S202) in the method 200 for monitoring an unmanned vehicle, according to an embodiment of the present disclosure. Refer to FIG. 5. The step of processing the operation data to retain the key portion data (S202) may include one or more of the following steps: the noise processing step (S501), the redundant data removal step (S502), the obstacle priority evaluation step (S503), and the key event extraction step (S504). In an embodiment, the foregoing four steps (S501 to S504) may be performed sequentially or in any order. In an embodiment, the foregoing four steps (S501 to S504) may be all performed, or any three of the steps may be performed, or any two of the steps may be performed, or any one of the steps may be performed.

Refer to FIG. 5. In the noise processing step (S501), the operation data of the unmanned vehicle 110 may be processed to retain the key portion data. In an embodiment, the operation data of the unmanned vehicle 110 includes data generated by various sensors. Because some noise, for example, false detection and positioning drift of a LiDAR, is inevitably introduced due to the data generated by the sensors, through the noise processing step (S501), the noise in the operation data may be filtered out and smoothed, to correct error information included in the operation data.

Refer to FIG. 5. In the redundant data removal step (S502), the operation data of the unmanned vehicle 110 may be processed to retain the key portion data. In an embodiment, in a complex environment, for example, an environment with a large quantity of static obstacles or cluttered objects, the operation data generated by the unmanned vehicle 110 during operation may include a large amount of redundant data, and the redundant data usually does not have a substantial impact on path planning. Through the redundant data removal step (S502), the redundant data that is not related to navigation decision-making may be removed from the operation data, to improve efficiency of processing the operation data.

Refer to FIG. 5. In the obstacle priority evaluation step (S503), the operation data of the unmanned vehicle 110 may be processed to retain the key portion data. In an embodiment, in a dynamic environment that changes frequently, the unmanned vehicle 110 may generate a large amount of operation data. To process important data in the operation data in real time, different priorities needs to be assigned to the data, to ensure that data with a high priority can be processed preferentially. Through the obstacle priority evaluation step (S503), a threat level of the obstacle in the operation data may be evaluated, and a priority is assigned to the obstacle. The threat level of the obstacle may be evaluated based on a proximity distance, a size, and a moving speed of the obstacle in the operation data. For example, an obstacle that is close to the unmanned vehicle 110 and with a large size and a high moving speed may be marked with a high priority; and a static object that is far away from the unmanned vehicle 110 and with a small size may be marked with a low priority, or be processed in a low priority. In other words, an obstacle with a higher threat level is assigned with a higher priority, and conversely, the obstacle is assigned a lower priority.

Refer to FIG. 5. In the key event extraction step (S504), the operation data of the unmanned vehicle 110 may be processed to retain the key portion data. In an embodiment, the operation data generated by the unmanned vehicle 110 during operation may include key event data. The key event data is data generated when the unmanned vehicle 110 encounters a key event, and the key event data is data that needs to be preferentially processed. The key event may include sudden appearance of an obstacle, a sudden change of path planning, and an abnormal change in speed. Through the key event extraction step (S504), the key event data may be extracted from the operation data.

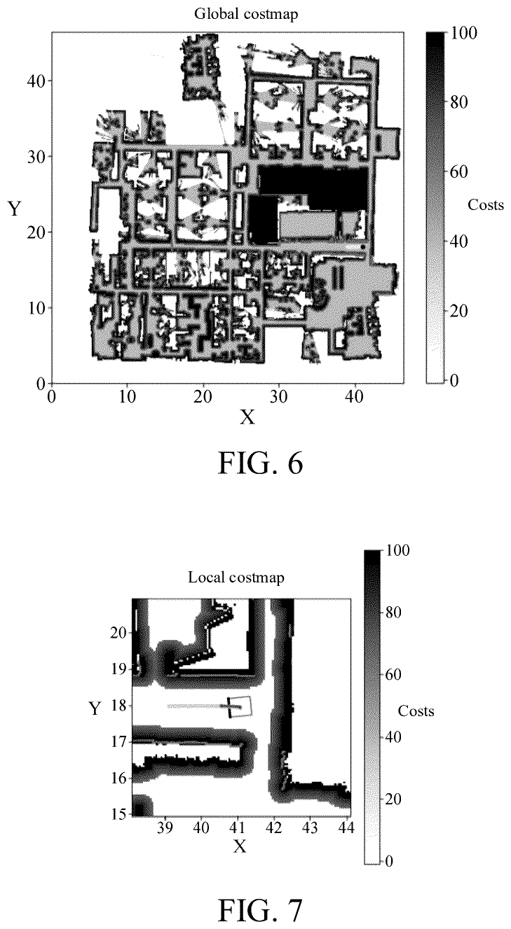

FIG. 6 is a schematic diagram of displaying a global costmap in the method 200 for monitoring an unmanned vehicle according to an embodiment of the present disclosure. FIG. 7 is a schematic diagram of displaying a local costmap in the method 200 for monitoring an unmanned vehicle according to an embodiment of the present disclosure. Refer to FIG. 6 and FIG. 7 together. In the embodiments of FIG. 6 and FIG. 7, the method 200 for monitoring an unmanned vehicle further includes a step of running a graphical user interface to generate one or more playback windows. The graphical user interface may include one or more playback windows, and the playback windows may display (or play) a picture or a video. In the embodiment of FIG. 6, the playback window of the graphical user interface may display (or play) a picture or a video presented in a form of a global costmap, to display information about an overall environment. The global costmap displayed in the playback window provides a long-distance path planned by the unmanned vehicle 110 in the overall environment. In the embodiment of FIG. 7, the playback window of the graphical user interface may display (or play) a picture or a video presented in a form of a local costmap, to highlight information about a specific area or position. The local costmap displayed in the play window provides detailed information about an environment of an adjacent area of the unmanned vehicle 110, including a fine navigation path. In an embodiment, the graphical user interface may include both the playback window for displaying the global costmap and the playback window for displaying the local costmap. According to the method 200 for monitoring an unmanned vehicle, efficiency of analyzing the operation data is greatly improved in a visualization manner. An analyst is enabled to intuitively monitor and analyze a real-time running condition of the unmanned vehicle 110 across platforms, so that a speed of problem diagnosis and resolution is improved.

In an embodiment, the method 200 for monitoring an unmanned vehicle further includes a visualization enhancement procedure. The visualization enhancement procedure may be executed to further improve a visualization effect of the key portion data in the operation data. The visualization enhancement procedure includes a data level marking step and a key event marking step. In the data level marking step, obstacles may be marked in different colors, different mark sizes or different color depths on the global costmap and the local costmap to indicate priorities of the obstacles in the operation data. In the key event marking step, a positioning mark or a highlight mark may be added to a timeline of the video, so that time of the key event in the operation data is highlighted on the timeline of the video. In addition, in a step of executing the visualization enhancement procedure, a key moment, such as a moment at which an obstacle appears or path planning changes, may be automatically jumped to during video playback, to help an analyst quickly locate and analyze an important event. In addition, in the step of executing the visualization enhancement procedure, a function may be provided through the graphical user interface, for a user to dynamically adjust a range and a level of detail of data displaying.

In an embodiment, the method 200 for monitoring an unmanned vehicle further includes an automated report generation procedure. The automated report generation procedure may be executed to generate an analysis report related to the operation data. The automated report generation procedure includes a key event report generation step and a trend analysis report generation step. In the key event report generation step, a key event report may be automatically generated based on key event data extracted from the operation data, where the generated key event report includes a key event time point, an unmanned vehicle status, and a sensor reading. In the trend analysis report generation step, a trend analysis report may be automatically generated based on the operation data obtained in long duration, where the generated trend analysis report includes a speed change trend, obstacle distribution statistics, and path planning efficiency. In an embodiment, the automated report generation procedure is based on a real-time data processing result, and can automatically generate a running report and support exporting the running report into a PDF or in a file format, to facilitate sharing and archiving. The method 200 for monitoring an unmanned vehicle of the present disclosure not only significantly improves efficiency of analyzing the operation data of the unmanned vehicle 110, but also ensures accuracy and reliability in a complex environment and a dynamic situation. This highly intelligent data processing method may become an important cornerstone in the fields of robot navigation and environment sensing in the future, and can greatly improve an adaptability and running efficiency of the unmanned vehicle 110.

Based on the above, according to the system and method for monitoring an unmanned vehicle provided in the present disclosure, the operation data of the unmanned vehicle can be collected, processed, and analyzed in real time, and the operation data is converted into a picture and a video that are visual. This not only resolves storage and retrieval problems caused by a large data amount of the operation data, but also provides intuitive data visualization, to facilitate analysis and monitoring, and an analyst can more intuitively understand an operating status of the unmanned vehicle. Therefore, a speed of problem diagnosis and resolution is improved. In addition, through the picture and video that are generated in the method for monitoring an unmanned vehicle in the present disclosure, analysis of the operation data of the unmanned vehicle is no longer limited to an environment of a robot operating system but can be performed across platforms. In other words, the operation data can be viewed and analyzed on a device (for example, a computer, a server, or a mobile device) that supports playback of a picture or a video. In addition, a real-time data processing and visualization technology provided in the method for monitoring an unmanned vehicle improves operation safety and efficiency of the unmanned vehicle, and can further reduce operation costs.

In terms of multi-level data filtering and optimization, the system of present disclosure will perform data filtering and eliminate redundant data to avoid storing static environmental information to reduce storage burden. Present disclosure also uses dynamic data prioritization to assign processing priorities corresponding to different obstacles. In addition, the system of present disclosure will detect and extract key events. When key events occur, the precision of data recording will be improved to ensure that relevant information is completely recorded. If an abnormal event is detected, the resolution will be automatically increased to ensure analysis accuracy. Navigation data usually only records key waypoints, and only when the route changes will the detailed trajectory change information be stored, further reducing the amount of storage.

For improving the efficiency of data retrieval, present disclosure uses an intelligent data indexing mechanism to automatically classify different types of events through event classification storage. In addition, the direct file access mechanism of present disclosure allows users to quickly retrieve key data based on file names without having to use frame-by-frame playback to find specific problem points, therefore further improving data analysis efficiency. Accordingly, the integrity of key portion data is ensured, while storage requirements are reduced and retrieval efficiency is improved.

What is claimed is:

1. A system for monitoring an unmanned vehicle, comprising:
an unmanned vehicle, generating operation data during operation; and
a data processing apparatus, including:
an initialization module for executing an initialization procedure, and the operation data being received;
a data processing module for processing the operation data, and key portion data being retained; and
a picture generation module for processing the key portion data, and a plurality of pictures being generated.

2. The system for monitoring an unmanned vehicle according to claim 1, wherein the initialization procedure comprises:
initializing a node of a robot operating system;
subscribing to a topic of the robot operating system to receive the operation data in real time;
determining whether there is an update for the operation data of the robot operating system; and
updating the operation data in response to that there is an update for the operation data.

3. The system for monitoring an unmanned vehicle according to claim 1, wherein the data processing module is for performing a data recording procedure including a first thread for processing the operation data, and a second thread for generating the plurality of pictures.

4. The system for monitoring an unmanned vehicle according to claim 3, wherein
the first thread comprises:
performing data screening;
writing data into a register; and
determining whether the first thread is completed; and
the second thread comprises:
determining whether the register includes a plurality of pieces of data; and
saving the plurality of pieces of data as the plurality of pictures.

5. The system for monitoring an unmanned vehicle according to claim 1, wherein the data processing module is for:
filtering and smoothing noise in the operation data;
remove redundant data unrelated to navigation decision-making from the operation data;
evaluating a threat level of an obstacle in the operation data;
assigning a priority to the obstacle; and
extracting key event data from the operation data.

6. The system for monitoring an unmanned vehicle according to claim 5, wherein the noise comprises false detection or positioning drift of a LiDAR, the redundant data comprises static obstacle data or cluttered object data, the threat level is evaluated based on a proximity distance, a size, or a moving speed of the obstacle, and the key event data comprises data related to a sudden appearance of the obstacle, a sudden change of path planning, and an abnormal change in speed.

7. The system for monitoring an unmanned vehicle according to claim 1, wherein the data processing apparatus further comprises a video generation module for merging the plurality of pictures to generate a video, wherein the picture generation module comprises a plotting library; the video generation module comprises a computer vision library, the plotting library is a Matplotlib plotting library, and the computer vision library is an OpenCV computer vision library.

8. The system for monitoring an unmanned vehicle according to claim 1, wherein the data processing apparatus further comprises a video generation module for merging the plurality of pictures to generate a video, wherein the data processing module is for performing a visualization enhancement procedure including:
adding a level mark of different colors or sizes to the picture to identify a priority of an obstacle in the operation data; and
adding a positioning mark or a highlight mark to a timeline of the video to highlight a key event in the operation data.

9. The system for monitoring an unmanned vehicle according to claim 1, wherein the data processing module is for performing an automated report generation procedure including:
automatically generating a key event report based on key event data extracted from the operation data, wherein the key event report includes a key event time point, an unmanned vehicle status, and a sensor reading; and
automatically generating a trend analysis report based on the operation data obtained in long duration, wherein the trend analysis report includes a speed change trend, obstacle distribution statistics, and path planning efficiency.

10. The system for monitoring an unmanned vehicle according to claim 1, wherein the data processing apparatus further comprises a video generation module, for merging the plurality of pictures to generate a video, wherein the system for monitoring an unmanned vehicle further comprises a graphical user interface, configured to display the picture or the video, and the picture or the video is presented in a form of a global costmap or a local costmap.

11. A method for monitoring an unmanned vehicle, wherein the method is applied to a data processing apparatus, and includes:
executing an initialization procedure, by using the data processing apparatus, and operation data being received;
processing the operation data, and key portion data being retained; and
processing the key portion data, and a plurality of pictures being generated, wherein
the operation data is data generated by an unmanned vehicle during operation.

12. The method for monitoring an unmanned vehicle according to claim 11, wherein the initialization procedure comprises:
initializing a node of a robot operating system;
subscribing to a topic of the robot operating system to receive the operation data in real time;
determining whether there is an update for the operation data; and
updating the operation data in response to that there is an update for the operation data.

13. The method for monitoring an unmanned vehicle according to claim 11, wherein the method further comprises: executing a data recording procedure including a first thread for processing the operation data, and a second thread for generating the plurality of pictures.

14. The method for monitoring an unmanned vehicle according to claim 13, wherein
the first thread comprises:
performing data screening;
writing data into a register; and
determining whether the first thread is completed; and
the second thread comprises:
determining whether the register includes a plurality of pieces of data; and
saving the plurality of pieces of data as the plurality of pictures.

15. The method for monitoring an unmanned vehicle according to claim 11, wherein the processing the operation data, and key portion data being retained comprises:
filtering and smoothing noise in the operation data;
removing redundant data that is unrelated to navigation decision-making from the operation data;
evaluating a threat level of an obstacle in the operation data;
assigning a priority to the obstacle; and
extracting key event data from the operation data.

16. The method for monitoring an unmanned vehicle according to claim 15, wherein the noise comprises false detection or positioning drift of a LiDAR, the redundant data comprises static obstacle data or cluttered object data, the threat level is evaluated based on a proximity distance, a size, or a moving speed of the obstacle, and the key event data comprises a key event, wherein the key event comprises a sudden appearance of the obstacle, a sudden change of path planning, and an abnormal change in speed.

17. The method for monitoring an unmanned vehicle according to claim 11, wherein the initialization procedure comprises a software library loading procedure including:
loading a plotting library; and
loading a computer vision library, wherein
the plotting library is a Matplotlib plotting library, and the computer vision library is an OpenCV computer vision library.

18. The method for monitoring an unmanned vehicle according to claim 11, wherein the method further comprises:
merging the plurality of pictures to generate a video; and
executing a visualization enhancement procedure including:
adding a level mark of different colors or sizes to the picture to identify a priority of an obstacle in the operation data; and
adding a positioning mark or a highlight mark to a timeline of the video to highlight a key event in the operation data.

19. The method for monitoring an unmanned vehicle according to claim 11, wherein the method further comprises:
executing an automated report generation procedure including:
automatically generating a key event report based on key event data extracted from the operation data, wherein the key event report includes a key event time point, an unmanned vehicle status, and a sensor reading; and
automatically generating a trend analysis report based on the operation data obtained in long duration, wherein the trend analysis report includes a speed change trend, obstacle distribution statistics, and path planning efficiency.

20. The method for monitoring an unmanned vehicle according to claim 11, wherein the method further comprises:
merging the plurality of pictures to generate a video; and
displaying the picture or the video, wherein the picture or the video is presented in a form of a global costmap or a local costmap.
